(19) United States
(12) Patent Application Publication
(10) Pub. No.: US 2010/0171763 A1
(43) Pub. Date: Jul. 8, 2010

(54) Organizing Digital Images Based on Locations of Capture

(75) Inventors: Nikhil Bhatt, Cupertino, CA (US); Eric Hanson, Emeryville, CA (US); Joshua Fagans, Redwood City, CA (US); Greg Gilley, Los Altos, CA (US); Timothy B. Martin, Sunnyvale, CA (US); Gregory Charles Lindley, Sunnyvale, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/545,765

(22) Filed: Aug. 21, 2009

Related U.S. Application Data
(60) Provisional application No. 61/142,558, filed on Jan. 5, 2009.

(51) Int. Cl. G09G 5/00; G06F 3/048

(52) U.S. Cl. 345/660; 715/800; 715/810; 715/764; 715/781

(57) ABSTRACT

Methods, apparatuses, and systems for organizing digital images based on locations of capture. On a small scale map of a geographic region that is displayed on a device, an object representing digital media items associated with a location in the geographic region are displayed. In response to receiving an input to display a portion of the map that includes the object, in a larger scale, multiple objects are displayed in the larger scale map, each of which represent a location of at least one of the multiple digital media items represented by the object in the small scale.

### CROSS-REFERENCE TO RELATED APPLICATIONS

This application claims priority to U.S. Provisional Application Ser. No. 61/142,558 filed on May 1, 2009, entitled “Organizing Digital Images based on Locations of Capture,” the entire contents of which are incorporated herein by reference.

### TECHNICAL FIELD

The present specification relates to presenting digital media, for example, digital photographs, digital video, and the like.

### BACKGROUND

Digital media includes digital photographs, electronic images, digital audio and/or video, and the like. Digital images can be captured using a wide variety of cameras, for example, high-end equipment such as digital single lens reflex (SLR) cameras, low resolution cameras including point-and-shoot cameras and cellular telephone instruments with suitable image capture capabilities. Such images can be transferred either individually as files or collectively as folders containing multiple files from the cameras to other devices including computers, printers, and storage devices. Software applications enable users to arrange, display, and edit digital photographs obtained from a camera or any other electronic image in a digital format. Such software applications provide a user in possession of a large repository of photographs with the capabilities to organize, view, and edit the photographs. Editing includes tagging photographs with one or more identifiers and manipulating images tagged with the same identifiers simultaneously. Additionally, software applications provide users with user interfaces to perform such tagging and manipulating operations, and to view the outcome of such operations. For example, a user can tag multiple photographs as being black and white images. A user interface, provided by the software application, allows the user to simultaneously transfer all tagged black and white photographs from one storage device to another in a one-step operation.

### SUMMARY

This specification describes technologies relating to organizing digital images based on associated location information, such as a location of capture.

Systems implementing techniques described here enable users to organize digital media, for example, digital images, that have been captured and stored, for example, on a computer-readable storage device. Geographic location information, such as information describing the location where the digital image was captured, can be associated with one or more digital images. The location information can be associated with the digital image either automatically, for example, through features built into the camera with which the photograph is taken, or subsequent to image capture, for example, by a user of a software application. Such information serves as an identifier attached to or otherwise associated with a digital image. Further, the geographic location information can be used to group images that share similar characteristics. For example, based on the geographic information, the systems described here can determine that all photographs in a group were captured in and around San Francisco, Calif. Subsequently, the systems can display, for example, one or more pins representing locations of one or more images on a map showing at least a portion of San Francisco. Further, when the systems determine that a new digital image was also taken in or around San Francisco, the systems can include the new photograph in the group. Details of these and additional techniques are described below.

The systems and techniques described here may provide one or more of the following advantages. Displaying objects on maps to represent locations allows users to create a travel-book of locations. Associating location-based identifiers with images enables grouping images associated with the same identifier. In addition to associating an identifier with each photograph, users can group multiple images that fall within the same geographic region, even if the proximate locations of different photographs are nonetheless different. Enabling the coalescing and dividing of objects based on zoom levels of the maps avoids cluttering of objects on maps while maintaining objects for each location.

The details of one or more implementations of the specification are set forth in the accompanying drawings and the description below. Other features, aspects, and advantages of the specification will become apparent from the description, the drawings, and the claims.

### BRIEF DESCRIPTION OF THE DRAWINGS

FIG. 1 is schematic of an exemplary user interface for displaying multiple images.

FIG. 2 is a schematic of an exemplary user interface for receiving image location.

FIG. 3 is a schematic of an exemplary user interface for displaying image location information.

FIGS. 4A-4C are schematics of exemplary user interfaces for displaying image locations at different zoom levels.

FIG. 5 is a schematic of an exemplary user interface for displaying image file metadata.

FIG. 6 is a schematic of an exemplary user interface for entering location information to be associated with an image.

Like reference numbers and designations in the various drawings indicate like elements.

### DETAILED DESCRIPTION

Digital media items, for example, digital images, digital photographs, and the like, can be captured at different locations. For example, a user who resides in San Jose, Calif., can capture multiple photographs at multiple locations, such as San Jose, Cupertino, Big Basin Redwoods State Park, and the like, while traveling across Northern California. Similarly, the user can also capture photographs in different cities across a state, in multiple states, and in multiple countries. The multiple photographs as well as locations in which the photographs are captured can be displayed in user interfaces that will be described later. Further, the systems and techniques described below enable a user to edit the information describing a location in which a photograph is captured and also to simultaneously manipulate multiple photographs that are related to each other based upon associated locations, such as if the locations are near each other.

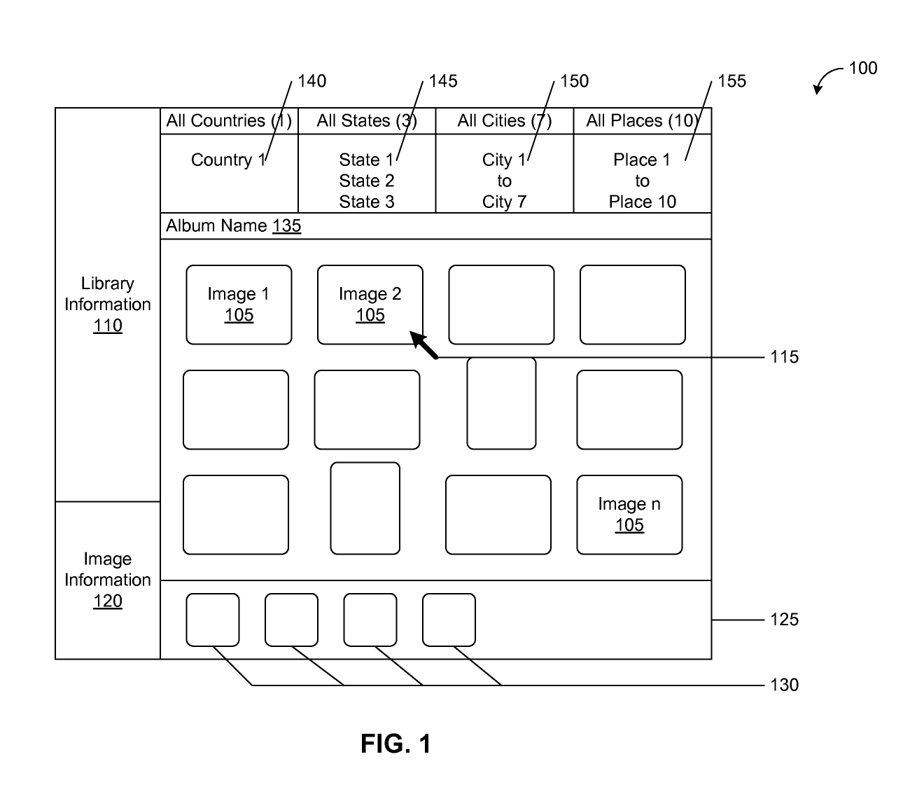

FIG. 1 is schematic of an exemplary user interface 100 for displaying multiple images. The user interface 100 can be displayed in a display device operatively coupled to a computer. Within the user interface 100, the images (Image 1, Image 2, . . . , Image n) can be displayed in either portrait or landscape orientation in corresponding thumbnails 105 that are arranged in an array. The images, that are stored, for example, on a computer-readable storage device, can be retrieved from the storage device and displayed as thumbnails 105 in the user interface 100. In addition, the storage device can include a library of multiple digital media items, for example, video, audio, other digital images, and the like. Information about the library can be displayed in the library information panel 110 in the user interface 100. For example, the storage device includes multiple folders and each folder includes multiple digital media items. The library information panel 110 displays the titles of one or more folders and links through which a user can access the contents of the displayed one or more folders. Additionally, links to recently accessed albums and images also can be displayed in the library information panel 110.

A user can access an image, for example, Image 2, by actuating the associated thumbnail 105. To do so, the user can position a cursor 115 that is controllable using, for example, a mouse, over the thumbnail 105 representing the image and opening that thumbnail 105. The mouse that controls the cursor 115 is operatively coupled to the computer to which the display device displaying the user interface 100 is coupled. Information related to the accessed image can be displayed in the image information panel 120. Such information can include a file name under which the digital image is stored in the storage device, a time when the image was captured, a file type, for example, JPEG, GIF, BMP, file size, and the like. In some implementations, information about an image can be displayed in the image information panel 120 when the user selects the thumbnail 105 representing the image. Alternatively, or in addition, image information can be displayed in the image information panel 120 when a user positions the cursor 115 over a thumbnail 105 in which the corresponding image is displayed.

In addition, the user interface 100 can include a control panel 125 in which multiple control buttons 130 can be displayed. Each control button 130 can be configured such that selecting the control button 130 enables a user to perform operations on the thumbnails 105 and/or the corresponding images. For example, selecting a control button 130 can enable a user to rotate a thumbnail 105 to change the orientation of an image from portrait to landscape, and vice versa. Any number of functions can be mapped to control buttons 130 in the control panel 125. Further, the user interface 100 can include a panel 135 for displaying the name of the album in which Image 1 to Image n are stored or otherwise organized. For example, the album name displayed in the panel 135 can be the name of the folder in which the images are stored in the storage device.

In some implementations, the user can provide geographic location information related to each image displayed in the user interface 100. The geographic location information can be information related to the location where the image was captured. The names of the locations and additional location information for a group of images can be collected and information about the collection can be displayed in panels 140, 145, 150, and 155 in the user interface. For example, if a user has captured Image 1 to Image n in different locations in the United States of America (USA), then all images that are displayed in thumbnails 105 in the user interface were captured in one country. Consequently, the panel 140 entitled “All Countries” displays “1” and the name of the country. Within the USA, the user can have captured a first set of images in a first state, a second set of images in a second state, and a third set of images in a third state. Therefore, the panel 145 entitled “All States” displays “3” and the names of the states in which the three sets of images were captured. Similarly, panel 150 entitled “All Cities” displays “7” and the names of seven cities, and panel 155 entitled “All Places” displays “10” and the names of ten places of interest in the seven cities.

The geographical designations or other such labels assigned to panels 140, 145, 150, and 155 can vary. For example, if it is determined that the place of interest is a group of islands, then an additional panel displaying the names of the islands in which images were captured can be displayed in the user interface 100. Alternatively, the names of the islands could be displayed under an existing panel, such as a panel corresponding to cities or places. The panels can be adapted to display any type of geographical information. For example, names of oceans, lakes, rivers, and the like also can be displayed in the user interface 100. In some implementations, two or more panels can be coalesced and displayed as a single panel. For example, panel 145 and panel 150 can be coalesced into one panel entitled “All States and Cities.” Techniques for receiving geographic location information, grouping images based on the information, and collecting information to display in panels such as panels 140, 145, 150, and 155 are described below.

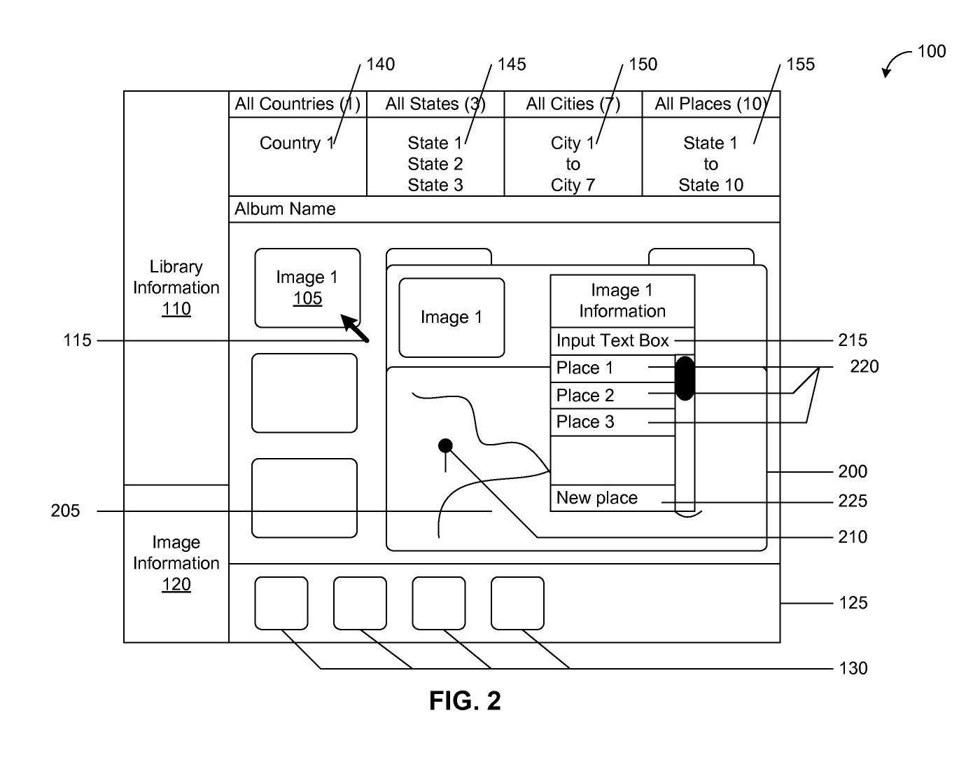

FIG. 2 is a schematic of an exemplary user interface 100 for receiving image location information. Image location refers to the geographic location information related to an image. In some implementations, the location information can be obtained when the image is captured. For example, the camera with which the user captures the image can be operatively coupled to a location identifier, for example, a Global Positioning System (GPS) receiver that is built-into the camera, such that when the image is captured, in addition to storing the image on a storage device, the GPS coordinates of the location in which the image is captured also are stored on the storage device. The GPS coordinates for an image can be associated with the image, for example, in the form of image file metadata. In some implementations, the user can capture the image using a first device, for example, a camera, obtain the GPS coordinates of the camera's location using a second device, and subsequently associate the GPS coordinates to one or more captured images, for example, by syncing the two devices.

As an alternative to, or in addition to, using GPS coordinates as geographic location information associated with captured images, the user can manually input a location corresponding to an image. The manually input location information can be associated with the corresponding image, such as in the form of image file metadata. In this manner, the user can create a database of locations in which images were captured. Once entered, the manually input locations also can be associated with additional images. Methods for providing the user with previously input locations to associate with new images is described later.

To associate geographic location information with an image, the user can select the image, for example, Image 1, using the cursor 115. In response, a location panel 200 can be displayed in the user interface 100. The location panel 200 can be presented such that it appears in front of one or more thumbnails 105. In some implementations, the selected image, namely Image 1, can be displayed as a thumbnail within the location panel 200. In implementations in which the geographic location of the selected image, for example, GPS coordinates, is known, a map 205 of an area including the location in which the selected image was captured can be displayed within the location panel 200. The map can be obtained from an external source (not shown). In addition, an object 210 resembling, for example, a pin, can be displayed in the map 205 at the location where the selected image was captured. In this manner, the object 210 displayed in the map 205 can graphically represent the location associated with the selected image.

In implementations in which the geographic location information is associated with the image after the selected image is uploaded into the user interface, the map 205 and the object 210 can be displayed after the location information is associated with the selected image. For example, when an image is selected for which no geographic location information is stored, the location panel 200 displays the thumbnail of the image. Subsequently, when the GPS coordinates and/or other location information are associated with the image, the map 205 is displayed in the location panel 200 and the object 210 representing the selected image is displayed in the map 205.

In some implementations, the camera that is used to capture the image and obtain the GPS coordinates also can include a repository of names of locations for which GPS coordinates are available. In such scenarios, the name of a location in which the selected image was captured can be retrieved from the repository and associated with the selected image, for example, as image file metadata. When such an image is displayed in the location panel 200, the name of the location can also be displayed in the location panel 200, for example, in the panel entitled “Image 1 Information.” In some scenarios, although the GPS coordinates are available, the names of locations are not available. In such scenarios, the names of the locations can be obtained from an external source, for example, a repository in which GPS coordinates of multiple locations and names of the multiple locations are stored.

For example, the display device in which the user interface 100 and the location panel 200 are displayed is operatively coupled to a computer that is connected to other computers through one or more networks, for example, the Internet. In such implementations, upon obtaining the GPS coordinates of selected images, the computer can access other computer-readable storage devices coupled to the Internet that store the names of locations and corresponding GPS coordinates. From such storage devices, names of the locations corresponding to the GPS coordinates of the selected image are retrieved and displayed in the location panel 200. The GPS coordinates obtained from an external source can include a range surrounding the coordinates, for example, a polygonal boundary having a specified planar shape. Alternatively, or in addition, the range can also be latitude/longitude values.

In scenarios where the computer is not coupled to a network, the user can manually input the name of a location into a text box displayed in the location panel 200, for example, the Input Text Box 215. As the user continues to input names of locations, a database of locations is created. Subsequently, when the user begins to enter the name of a location for a selected image, names of previously entered locations are retrieved from the database and provided to the user as suggestions available for selection. For example, if the user enters “Bi” in the Input Text Box 215, and if “Big Basin,” “Big Sur,” and “Bishop,” are names of three locations that have previously been entered and stored in the database, then based on the similarity in spelling of the places and the text entered in the Input Text Box 215, these three places are displayed to the user, for example, in selectable text boxes 220 entitled “Place 1,” Place 2,” and “Place 3,” so that the user can select the text box corresponding to the name of the location rather than re-enter the name. As additional text is entered into the Input Text Box 215, existing location names that no longer represent a match can be eliminated from the selectable text boxes 220. In some implementations, the database of locations can be provided to select locations even when the computer is coupled to the network. In some implementations, a previously created database of locations is provided to the user from which the user can select names of existing locations and to which the user can add names of new locations.

In some implementations, the name of the location can be new, and therefore not in the database. In such implementations, the user can select the text box 225 entitled “New place,” enter the name of the new location, and assign the new location to the selected image. The new location is stored in the database of locations and is available as a suggestion for names that are to be associated with future selected images. Alternatively, a new location can be stored in the database without accessing the text box 225 if the text in the Input Text Box 215 does not match any of the location names stored in the database. Once the user enters the name of a location or selects a name from the suggested names, the text boxes 215, 220, and 225 can be hidden from display. Subsequently, a thumbnail of the selected image, information related to the image, the map 205 and the object 210 are displayed in the location panel 200.

When a user enters a name of a new location, the user can also provide geographic location information, for example, latitude/longitude points, for the new location. In addition, the user can also provide a range, for example, in miles, that specifies an approximate size around the points. The combination of the latitude/longitude points and the range provided by the user represents the range covered by the new location. The name of the new location, the location information, and the range are stored in the database. Subsequently, when the user provides geographic location information for a second new location, if it is determined that the location information for the second new location lies within the range of the stored new location, then the two new locations can be grouped.

Geographic location information for multiple known locations can be collected to form a database. For example, the GPS coordinates for several hundreds of thousands of locations, the names of the locations in one or more languages, and a geographical hierarchy of the locations can be stored in the database. Each location can be associated with a corresponding range that represents the geographical area that is covered by the location. For example, a central point can be selected in San Francisco, Calif., such as downtown San Francisco, and a five-mile circular range can be associated with this central point. The central point can represent any center, such as a geographic center or a social/population center. Thus, any location within a five-mile circular range from downtown San Francisco is considered to be lying within and thus associated with San Francisco. The example range described here is circular. Alternatively, or in addition, the range can be represented by any planar surface, for example, a polygon. In some implementations, for a location, the user can select the central point, the range, and the shape of the range. For example, for San Francisco, the user can select downtown San Francisco as the central point, specify a range of five miles, and specify that the range should be a hexagonal shape in which downtown San Francisco is located at the center.

In some implementations, to determine that a new location at which a new image was captured lies within a range of a location stored in the database, a distance between the GPS coordinates of the central point of the stored location and that of the new location can be determined. Based on the shape of the range for the stored location, if the distance is within the range for the stored location, then the new location is associated with the stored location. In some implementations, the range from a central point for each location need not be distinct. In other words, two or more ranges can overlap. Alternatively, the ranges can be distinct. When the geographic location information associated with a new image indicates that the location associated with the new image lies within two ranges of two central points, then, in some implementations, the location can be associated with both central points. Alternatively, the location of the new image can be associated with one of the two central points based on a distance between the location and the central point. In the geographical hierarchy, a collection of ranges of locations at a lower level can be the range of a location at a higher level. For example, the sum of ranges of each city in California can be the range of the state of California. Further, in some implementations, the boundaries of a territory, such as a city or place of interest, can be expanded by a certain distance outside of the land border. Thus, e.g., a photograph taken just off shore of San Francisco, such as on a boat, can be associated with San Francisco instead of the Pacific Ocean. The boundaries of a territory can be expanded by any distance, and in some implementations the amount of expansion for any given territory can be customized. For example, the boundaries of a country can be expanded by a large distance, such as 200 miles, while the boundaries of a city can be expanded by a smaller distance, such as 20 miles.

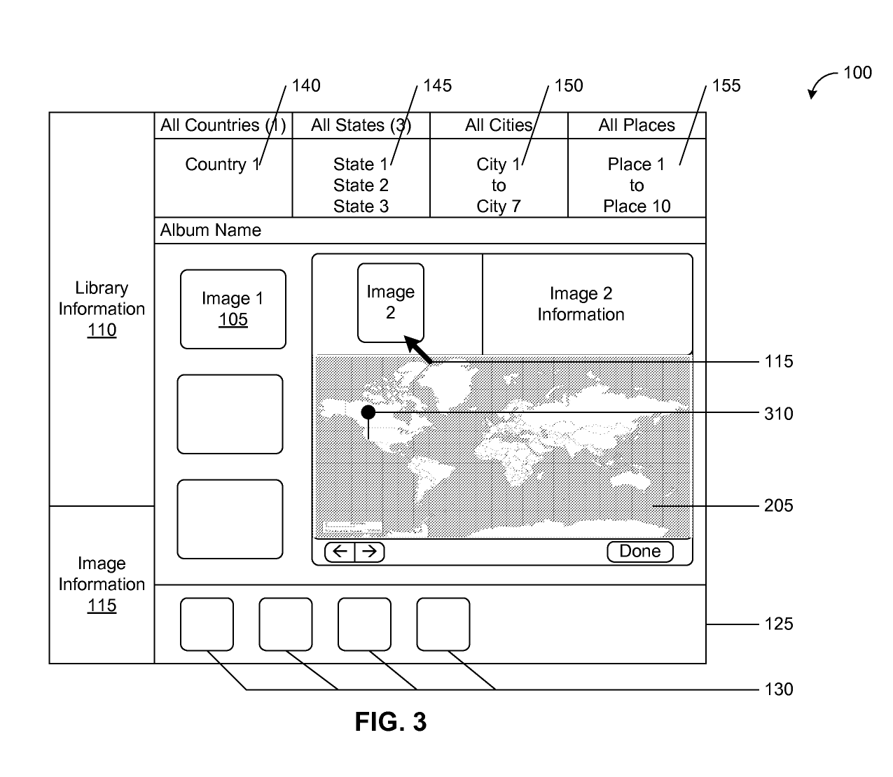

FIG. 3 is a schematic of an exemplary user interface 100 for displaying image location information. When images, for example, Image 1 to Image n, have been associated with corresponding locations of capture, two or more images can be grouped based on location. For example, if Image 1 and Image 2 were both taken in Big Basin Redwoods State Park in California, USA, then both images can be grouped based on the common location. Further, a location-based association can be formed without respect to time, such that Image 1 and Image 2 can be associated regardless of the time period by which they are separated.

In scenarios in which the locations are based on GPS coordinates, the coordinates of two images may not be the same, even though the locations in which the two images were captured are near one another. For example, if the user captures Image 1 at a first location in Big Basin Redwoods State Park and Image 2 at a second location in the park, but at a distance of five miles from the first location, then the GPS coordinates associated with Image 1 and Image 2 are not the same. However, based on the above-description, both images can be grouped together using Big Basin Redwoods State Park as a common location if Image 2 falls within the geographical area associated with the central point of Image 1.

In some implementations, instead of the geographical hierarchy being based on countries, states, cities, and the like, the hierarchy of grouping can be distance-based, such as in accordance with a predetermined radius. For example, a five mile range can be the lowest level in the hierarchy. As the hierarchy progresses from the lowest to the highest level, the range can also increase from five miles to, for example, 25 miles, 50 miles, 100 miles, 200 miles, and so on. In such scenarios, two images that were captured at locations that are 60 miles apart can be grouped at a higher level in the hierarchy, such as a grouping based on a 100 mile range, but not grouped at a lower level in the hierarchy, such as a grouping based on a 50 mile range. In some implementations, the default ranges can be altered in accordance with user input. Thus, a user can specify, e.g., that the range of the lowest level of the hierarchy is three miles.

Alternatively, or in addition, the range for each level in the hierarchy can be based upon the location in which the images are being captured. For example, if, based on GPS coordinates or user specification, it is determined that the first image was captured within the boundaries of a specific location, such as Redwoods State Park, Disneyland, or the like, then the range of the lowest level of the hierarchy can be determined based on the boundaries of that location. To do so, for example, the GPS coordinates of the boundaries of Redwoods State Park can be obtained and the distances of the reference location from the boundaries can be determined. Subsequently, if it is determined that a location of a new image falls within the boundaries of the park, then the new image can be grouped with the reference image. A higher level of hierarchy can be determined to be the boundary of a larger location, for example, the boundaries of a state or country. An intermediate level of hierarchy can be the boundary of a region within a larger location, for example, the boundaries of Northern California or a county, such as Sonoma. Any number of levels can be defined within a hierarchy. Thus, all captured images can be grouped based on the levels of the hierarchy.

In some implementations, a user can increase or decrease the boundaries associated with a location. For example, the user can expand the boundary of Redwoods State Park by a desired amount, e.g., one mile, such that an image captured within the expanded boundaries of the park is grouped with all of the images captured within the park. In some scenarios, the distance by which the boundary is expanded can depend upon the position of a location in the hierarchy. Thus, in a default implementation, at a higher level, the distance can be higher. For example, because “Country” represents a higher level in the geographical hierarchy, the default distance by which the boundary is expanded can be 200 miles. In comparison, at a lower level in hierarchy, such as “State” level, the default distance can be 20 miles. The distances can be altered based on user input.

In some implementations, the user can specify a new reference image and identify a new reference location. For example, after capturing images in California, the user can travel to Texas, capture a new image, and specify the location of the new image as the new reference location. Alternatively, it can be determined that a distance between a location of the new image and that of the previous reference image is greater than a threshold. Because the location of the new image exceeds the threshold distance from the reference location, the location of the new image can be assigned as the new reference location.

The hierarchy of grouping can be considered to be similar to a tree structure having one root node, multiple intermediary nodes, and multiple leaf nodes. Information about the images that is collected based on the grouping described above can include a number of nodes at each level in the hierarchy. For example, in the user interface 100 illustrated in FIG. 3, panels 140, 145, 150, and 155 display information collected from grouped images. In this example, panel 140 entitled “All Countries” represents the highest level in the hierarchy and is the root node of the tree structure representing the hierarchy. Because a tree has one root node, the panel 140 displays “1” indicating that all images in the group were taken in one country. Similarly, panel 155 entitled “All Places” represents the lowest level in the hierarchy. This panel displays “10” indicating that the images were taken at ten places of interest. This also represents that the tree structure has ten leaf nodes.

Although four panels displaying collected information are displayed in the example user interface 100 of FIG. 3, different or additional panels representing other criteria can also be displayed. The number of panels displaying information can be based upon the number of hierarchical levels of grouping. For example, if all captured images are grouped into ten hierarchical levels, then ten panels displaying collected information for each level can be presented in the user interface 100. In some implementations, the number of panels that is displayed can be varied by user input. Additionally, the levels of panels that are displayed can also be varied by user input. For example, if the user captures multiple images on multiple islands in the state of Hawaii, then at least five panels displaying collected information can be displayed in the user interface 100. The panels can be entitled “My Countries,” “My States,” “My Islands,” “My Cities,” and “My Places.”

In some implementations, the granularity of the map 205 can be varied in response to user input, such as commands to zoom in or out. To zoom into the map, the user can position the cursor 115 at any location on the map and select the position. In response, the region around the selected position can be displayed in a larger scale. For example, user interface 100 in FIG. 2 displays a zoomed in view and user interface 100 in FIG. 3 displays a zoomed out view of the same map 205. While the map 205 in FIG. 2 displays an object representing a location associated with Image 1, the map 205 in FIG. 3 displays an object representing a location associated with Image 2. As described in the previous example, Image 1 and Image 2 were captured at locations that are within a five mile range of each other. Although the location of each of Image 1 and Image 2 can be represented by a corresponding object 310, the locations for both images are represented by the same object 310 in the zoomed out view of the map 205. Thus, instead of displaying two objects in the zoomed out view, the objects are coalesced and displayed as a single object 310. When the user zooms into the map 205, the coalesced single object 310 can be divided into two objects 210 for the two images, Image 1 and Image 2.

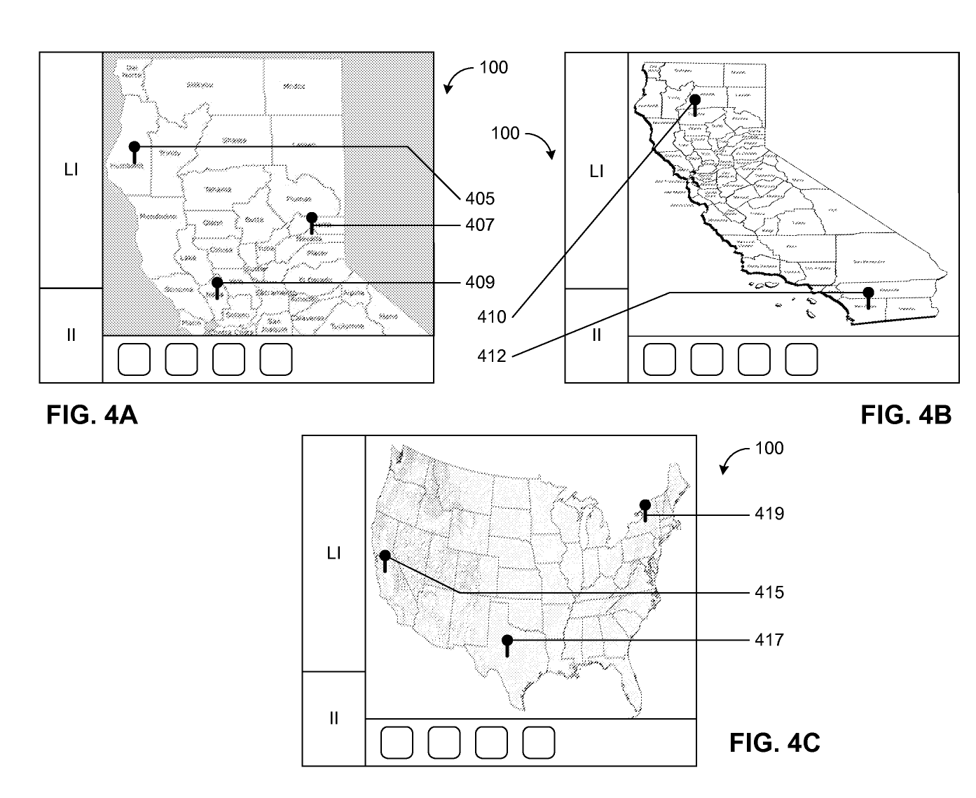

FIGS. 4A-4C are schematics of exemplary user interfaces 100 for displaying image locations at different zoom levels. The example user interfaces 100 include images that were captured in New York, Texas, and California. Further, images were captured in northern and southern regions of California, and at multiple locations in Northern California. The locations in Northern California corresponding to where images were captured are displayed by objects 405, 407, and 409 in a zoomed in view of the map displayed in the user interface 100 of FIG. 4A. In response to a zoom input from the user, the zoom level can be decreased and the map is zoomed out to the map displayed in the user interface 100 of FIG. 4B. When zoomed out to a level showing the state of California, the objects 405, 407, and 409 are coalesced into one object 410 indicating the images captured in Northern California. Additionally, the object 412 displayed on the map in the user interface 100 indicates that one or more images were captured in Southern California. Each object represents a gallery of one or more images that can be accessed by selecting the object. Thus, when two objects are coalesced, the galleries corresponding to those objects are logically combined such that they are accessed together. Similarly, when a single object is separated into two or more objects, the galleries corresponding to those objects also are separated and thus independently accessible. When the user decreases the zoom level from the view of the map in FIG. 4B, the view zooms out to the view of the map in FIG. 4C. In this view, the objects 410 and 412 are coalesced into a single object 415 that is displayed in association with California. Additionally, object 417 is displayed in association with Texas and object 419 is displayed in association with New York, indicating that one or more images were captured in each of those states.

In some implementations, the user can provide input to change the zoom level of the map using, e.g., a cursor controlled by a mouse. For example, in the user interface 100 of FIG. 4C, the user positions the cursor over or adjacent to the object 415 displayed over Texas and double-clicks the map. In response, a zoom level of the map is increased from a high level to a zoomed in view of the map. For example, a map of Texas is displayed in the user interface 100 in place of the map of the USA. If multiple images were captured at multiple locations in Texas, then the object 417 is divided into the multiple objects and each object is displayed over a region in the map that corresponds to the region in Texas where the images were captured. The user can continue to increase the zoom level of each view of the map until the object represents one or more images taken in a single location. Subsequently, when the user positions the cursor over the object, a thumbnail representative of the one or more images is displayed adjacent to the object in the user interface 100.

In some implementations, the map displayed in the user interface 100 can be obtained from an external source, for example, a computer-readable storage device operatively coupled to multiple computers through the Internet. In addition, the storage device on which the map is stored can also store zoom levels for multiple views of the map. The views of the maps displayed in the user interfaces of FIGS. 4A-4C can be zoomed based on the zoom levels received with the map. To coalesce multiple objects into a single object, it can be determined if the input to decrease the zoom level and zoom out of a region of the map will cause two objects representing separate locations to be placed adjacent to each other such that the two objects are overlapping each other. If the objects will overlap each other, then the objects can be coalesced into a single object. Conversely, if zooming into a region of a map will cause two or more objects that were otherwise overlapping, and thus coalesced into a single gallery, to be displayed separately, then the object can be divided into two or more separate objects. In this manner, depending upon the zoom levels of the maps displayed in the user interface 100, multiple objects can be coalesced into a single object and vice versa.

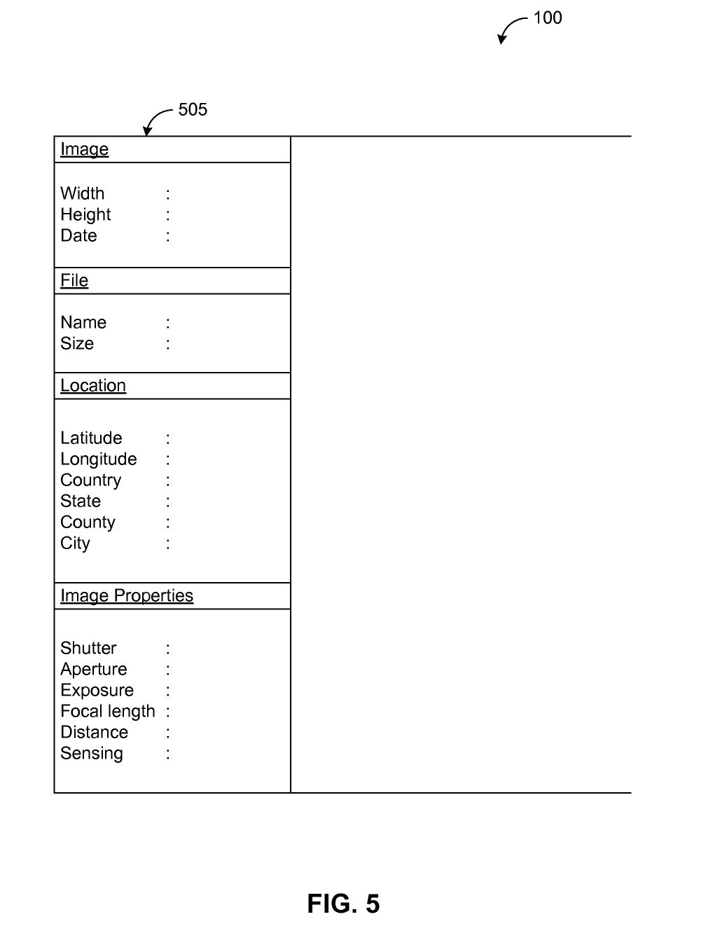

FIG. 5 is a schematic of an exemplary user interface 100 for displaying image file metadata. In some implementations, to zoom into a map, the user can select an object, for example, object 410 that is displayed on the map. In response, the zoomed in view of the region on the map surrounding the object can be displayed in the user interface 100. If the object is a coalesced representation of multiple objects representing multiple locations, the coalesced object can be divided into multiple objects and the zoomed in view can show the multiple objects separately. The user can continue to zoom into the map until an object represents one or more images taken in a single location. Further, positioning the cursor over the object can cause one or more images associated with the object to be displayed in a thumbnail adjacent to the object. To view the gallery associated with the object, the user can select the object. In response, the one or more images included in the gallery can be displayed in the user interface 100, for example, in place of or adjacent to the map.

In addition to displaying an image in the user interface 100, a corresponding image information panel 505 can be displayed adjacent to the image. The image information panel 505 includes image file metadata associated with the displayed image. The metadata is associated with the image file on the storage device on which the file is stored, and is retrieved when the image file is retrieved. The image file metadata can include image information, file information, location information, such as the GPS coordinates of the location in which the image was captured, image properties, and the like.

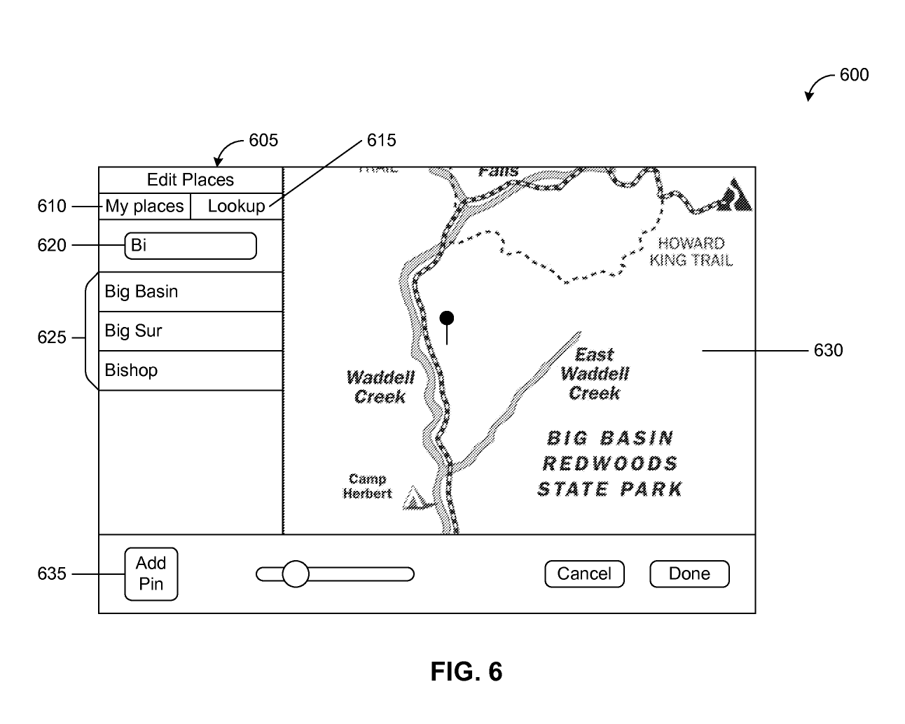

FIG. 6 is a schematic of an exemplary user interface 600 for entering location information to be associated with an image after the image has been captured. Using user interface 600, a database of locations can be created and modified. For example, prior to travel, a user can create a database of locations that the user intends to visit. To enable the user to do so, an editing panel 605 can be displayed in the user interface 600. The editing panel 605 includes a selectable bounded region 610 entitled, for example, “My places.” Selecting the bounded region 610 causes available locations to be displayed in the user interface 600. The user can select and add one or more available locations to the database. The available locations can be extracted from one or more sources, for example, a database of locations that was previously created by the user, an address book maintained by the user on a computer, and the like. For example, the user can maintain an address book that lists the user's home address as “My home.” Selecting the bounded region 610 can cause “My home” to be displayed in the user interface 600 as one of the available locations. In addition, the address associated with “My home” is the user's home address as stated in the user's address book.

In some implementations, an additional bounded region 615 can be displayed in the user interface 600. Selecting the bounded region 615 can enable a user to search for locations. For example, in response to detecting a selection of the bounded region 615, a text box 620 can be displayed in the user interface 600. The user can enter a location name in the text box 620. If one or more matching location names are available either in a previously created database of locations or in the user's address book, then each matching location name can be displayed in the bounded region 625 of the user interface 600. In some implementations, as the user is entering text into the text box 620, names of one or more suggested locations can be displayed in the user interface 600 in bounded regions 625. For example, when the user enters “B” in text box 610, then names of available locations that start with the letter “B” can be displayed in the bounded region 625. Subsequently, when the user enters the next letter, such as the letter “I,” the list of names of matching available locations can be narrowed to those that begin with “Bi.”

In some implementations, the names of suggested locations presented in the bounded region 625 can be ordered based only on the text entered in the text box 620, such as alphabetically. In some other implementations, the list of suggested locations can be ordered based on a proximity of an available location to a reference location, e.g., the user's address. For example, if the user resides in Cupertino, Calif., and the user's Cupertino address is stored, then the list of suggested available locations can be ordered based on distance from the user's Cupertino address. Thus, when the user enters the letter “B” in the text box 620, the first location that is suggested to the user not only begins with the letter “B’ but is also the nearest matching location to the user's Cupertino address. This location is displayed immediately below text box 620 in a bounded region 625. The location that is displayed as a second suggested location in the user interface 600 also begins with the letter “B” and is the second nearest matching location from the Cupertino address. Because the suggested location is already available in a database, the geographic location information for that location, for example, GPS coordinates is also available, and consequently, the distance between a suggested location and the reference location can be determined.

Alternatively, or in addition, in some implementations, locations can be suggested based upon a number of images that have previously been captured at that location. For example, the user has previously captured 50 images at a location titled “Washington Monument.” The user also can have captured 10 images at a location titled “Washington State University.” When the user enters “Washington” in the text box 620, the location name “Washington Monument” is displayed ahead of the location name “Washington State University” because more images were taken at the location titled “Washington Monument” than at the location titled “Washington State University”. In this manner, the user can receive suggested location names based on available locations. Using similar techniques, a user can retrieve available locations and perform operations including retrieving all images that were captured at that location, changing geographic location information for the location, re-naming the location, and the like. When the user selects a location for inclusion in a database, a map 630 of the region surrounding the location can be displayed in the user interface 600. Because the location is already available, one or more maps corresponding to the location also may be available. If a particular map is not available, the map can be retrieved from an external source and displayed in the user interface 600. Subsequently, the user can select the bounded region 635 entitled “Add Pin” to add an object representing the location to the map 630.

In addition to creating and modifying a database of locations, the techniques described here can be used to name locations for which geographic location information, for example, GPS coordinates, is available, but for which names are not available. For example, when the user captures images with a digital camera and location information with a GPS device, and syncs the two devices, then the user can associate the GPS coordinates with one or more images. To enable the user to do so, one or more images can be displayed in the user interface 630, for example, using thumbnails. The user can select a thumbnail and associate the corresponding GPS coordinates with the image. Subsequently, using the techniques described previously, the user can assign a name to the location represented by the GPS coordinates and the location name can be saved in the database of locations.

The processes described above can be implemented in a computer-readable medium tangibly encoding software instructions which are executable, for example, by one or more computers to cause the one or more computers or one or more data processing apparatus to perform the operations described here. In addition, the techniques can be implemented in a system including one or more computer and the computer-readable medium.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a random or serial access memory device, or a combination of one or more of them.

The term “processing device” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other module suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the specification or of what may be claimed, but rather as descriptions of features specific to particular implementations of the specification. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Thus, particular implementations of the specification have been described. Other implementations are within the scope of the following claims. For example, the actions recited in the claims can be performed in a different order and still achieve desirable results.

In some implementations, the user interface 100 can be divided into multiple columns, each of which represents one of the levels in the geographical hierarchy. Within each column, the name of a location in which each image in the geographical hierarchy was captured can be displayed. When a user selects a column, the other columns in the user interface 100 can be hidden from display and each image corresponding to each name displayed in the column can be displayed in the user interface 100 in corresponding thumbnails. Selecting one of the thumbnails can cause the map that includes the location in which the image displayed in the thumbnail was captured, to be displayed in the user interface 100. Based on user input, the zoom levels of the displayed map can be varied.

In some implementations, one or more images can be associated with a central location on a map for which GPS coordinates are available. Each of the one or more images is associated with a corresponding GPS coordinate. A distance between each of the one or more images and the central location can be determined based on the GPS coordinates. If the distance is within a threshold, then the one or more images are associated with the central location.

In some implementations, a boundary can be associated with a location for which a GPS coordinate is available. For example, if a user provides a name for a location, and the location is determined to be a popular location, such as an amusement park, then a size of the boundary can be determined based on the nature of the popular location. If it is determined that GPS coordinates of a location in which an image is taken are within the boundary determined for the popular location, then the image is associated with the popular location.

In some implementations, multiple images can be retrieved from one or more computer-readable storage devices, and geographic location information for each image can be obtained simultaneously.

In some implementations, an image and associated geographic location information, for example, GPS coordinates, can be stored in a database on a computer-readable storage device, for example, a server, that is operatively coupled to a user's computer through one or more networks, for example, the Internet. The server can store information about each image as a record. A record can include, for example, the image file, geographic location of the image, range information, and the like. A version number can be associated with each record stored on the server. The user can access and retrieve a record from the server, and store the record on a computer-readable storage device operatively coupled to the user's computer. When the user does so, the version number for the record which is stored on the server is also stored on the user's storage device.

Subsequently, a portion of information stored on the server can be altered. For example, the polygonal boundary that specifies the range associated with the GPS coordinates of the stored image can be increased or decreased. When such information is altered, then the record including the altered information is stored as a new record. The new version number is associated with the new record and the previous version number is retained. The previous and new version numbers enable identifying the portion of information in the record that was altered.

When the server storing the record is accessed, for example, in response to user input, then the version number stored in the user's storage device is compared with the database storing records of images to determine if the image has been updated. Upon determining that the version number received from the user has an associated new version number in the database, it is concluded that the record associated with the image has been altered. In some implementations, the altered record with the new version number can be retrieved and stored on the user's storage device. Alternatively, or in addition, changes to the altered record in comparison to the record stored on the user's storage device can be determined, and provided to the user. Based on user input, the changes to the altered record can be stored in the user's storage device or rejected.

In some implementations, locations can be displayed based on time. For example, a location can have changed over time. Depending upon a received time, for example, a date retrieved from a stored image, the map of a location, as it appeared on the retrieved date, can be displayed in the user interface 100. Other examples of locations changing over time include a change in name of the location, change in boundaries of the location, and the like.

The operations described herein can be performed on any type of digital media including digital video, digital audio, and the like, for which geographic location information is available.

What is claimed is:

1. A system comprising:
one or more computers, wherein at least one computer is coupled to a display device; and
a computer-readable medium tangibly encoding software instructions which are executable to cause the one or more computers to perform operations comprising:
displaying in a map of a geographic region on the display device, a first object representing a plurality of digital media items associated with a location in the geographic region;
receiving an input to display a portion of the map in a larger scale, wherein the portion of the map represents a geographic area including the location of the object; and
in response to receiving the input, displaying a plurality of second objects in the map of the geographic area, each of the plurality of second objects representing a location of at least one of the plurality of digital media items.

2. The system of claim 1, wherein the plurality of digital items comprise digital photographs.

3. The system of claim 2, wherein the location of the first object in the map represents a region in which the plurality of digital photographs were captured.

4. The system of claim 2, wherein each of the plurality of second objects represents a subset of the plurality of digital media items associated with the first object.

5. The system of claim 1, wherein, in response to receiving the input, display of the first object is terminated.

6. The system of claim 1, the operations further comprising:
receiving input to display the map in a smaller scale, the received input causing the map of the geographic region to be displayed in place of the map of the geographic area; and
displaying the first object representing the plurality of digital media items in place of the plurality of second objects.

7. A computer-readable medium tangibly encoding software instructions which are executable to cause one or more data processing apparatus to perform operations comprising:
displaying in a map of a geographic region on the display device, a first object representing a plurality of digital media items associated with a location in the geographic region;
receiving an input to display a portion of the map in a larger scale, wherein the portion of the map represents a geographic area including the location of the object; and
in response to receiving the input, displaying a plurality of second objects in the map of the geographic area, each of the plurality of second objects representing a location of at least one of the plurality of digital media items.

8. The computer-readable medium of claim 7, wherein the plurality of digital items comprise digital photographs.

9. The computer-readable medium of claim 8, wherein the location of the first object in the map represents a region in which the plurality of digital photographs were captured.

10. The computer-readable medium of claim 8, wherein each of the plurality of second objects represents a subset of the plurality of digital media items associated with the first object.

11. The computer-readable medium of claim 7, wherein, in response to receiving the input, display of the first object is terminated.

12. The computer-readable medium of claim 7, the operations further comprising:
receiving input to display the map in a smaller scale, the received input causing the map of the geographic region to be displayed in place of the map of the geographic area; and
displaying the first object representing the plurality of digital media items in place of the plurality of second objects.

13. A computer-implemented method comprising:
displaying in a map of a geographic region on the display device, a first object representing a plurality of digital media items associated with a location in the geographic region;
receiving an input to display a portion of the map in a larger scale, wherein the portion of the map represents a geographic area including the location of the object; and
in response to receiving the input, displaying a plurality of second objects in the map of the geographic area, each of the plurality of second objects representing a location of at least one of the plurality of digital media items.

14. The method of claim 13, wherein the plurality of digital items comprise digital photographs.

15. The method of claim 14, wherein the location of the first object in the map represents a region in which the plurality of digital photographs were captured.

16. The method of claim 14, wherein each of the plurality of second objects represents a subset of the plurality of digital media items associated with the first object.

17. The method of claim 13, wherein, in response to receiving the input, display of the first object is terminated.

18. The method of claim 13, further comprising:
receiving input to display the map in a smaller scale, the received input causing the map of the geographic region to be displayed in place of the map of the geographic area; and
displaying the first object representing the plurality of digital media items in place of the plurality of second objects.

19. A computer-readable medium tangibly encoding software instructions which are executable to cause one or more data processing apparatus to perform operations comprising:
displaying, in a display device, a plurality of objects representing a corresponding plurality of digital media items in a map of a geographic area that is also displayed in the display device, wherein a location of each object in the map represents a corresponding geographic location of the corresponding digital media item in the geographic area;
receiving an input to zoom out to a geographic region that includes the geographic area, the input causing a map of the geographic region to be displayed in the display device; and
in response to the receiving, displaying an object in the map of the geographic region that collectively represents the plurality of digital media items, wherein a location of the object collectively represents geographic locations of the corresponding digital media item in the geographic region.

20. The medium of claim 19, the operations further comprising:
receiving a new input to zoom into the geographic area, the new input causing the map of the geographic area to be displayed in place of the map of the geographic region; and
in response to the receiving, displaying the plurality of objects representing the plurality of digital media items in place of the object.

21. A system comprising:
one or more computers, wherein at least one computer is coupled to a display device; and
a computer-readable medium tangibly encoding software instructions which are executable to cause the one or more computers to perform operations comprising:
displaying, in a display device, a plurality of objects representing a corresponding plurality of digital media items in a map of a geographic area that is also displayed in the display device, wherein a location of each object in the map represents a corresponding geographic location of the corresponding digital media item in the geographic area;
receiving an input to zoom out to a geographic region that includes the geographic area, the input causing a map of the geographic region to be displayed in the display device; and
in response to the receiving, displaying an object in the map of the geographic region that collectively represents the plurality of digital media items, wherein a location of the object collectively represents geographic locations of the corresponding digital media item in the geographic region.

22. The system of claim 21, the operations further comprising:
receiving a new input to zoom into the geographic area, the new input causing the map of the geographic area to be displayed in place of the map of the geographic region; and
in response to the receiving, displaying the plurality of objects representing the plurality of digital media items in place of the object.

23. A computer-implemented method comprising:
displaying, in a display device, a plurality of objects representing a corresponding plurality of digital media items in a map of a geographic area that is also displayed in the display device, wherein a location of each object in the map represents a corresponding geographic location of the corresponding digital media item in the geographic area;
receiving an input to zoom out to a geographic region that includes the geographic area, the input causing a map of the geographic region to be displayed in the display device; and
in response to the receiving, displaying an object in the map of the geographic region that collectively represents the plurality of digital media items, wherein a location of the object collectively represents geographic locations of the corresponding digital media item in the geographic region.

24. The method of claim 23, further comprising:
receiving a new input to zoom into the geographic area, the new input causing the map of the geographic area to be displayed in place of the map of the geographic region; and
in response to the receiving, displaying the plurality of objects representing the plurality of digital media items in place of the object.

25. A computer-implemented method comprising:
displaying a plurality of objects in a map of a geographic region displayed in a display device, each of the plurality of objects representing one or more locations of a plurality of locations, wherein each of the plurality of objects are related to one or more digital media items;
receiving an input to change a zoom level of the map, the input causing a new map of a new geographic region to be displayed in place of the map in the display device; and
in response to the receiving, displaying one or more new objects representing corresponding one or more new locations within the new geographic region, wherein a number of the one or more objects is altered from a number of the plurality of objects based on the change to the zoom level of the map.

26. The method of claim 25, wherein the input to change the zoom level is an input to zoom into the map of the geographic region, the method further comprising:
determining that a new object of the one or more new objects represents more than one location of the plurality of locations;
dividing the new object into additional new objects, each additional new object representing one or more locations of the plurality of locations; and
displaying the additional new objects in the new map.

27. The method of claim 25, wherein the input to change the zoom level is an input to zoom out of the map of the geographic region, the method further comprising:
determining that a region of the new map includes a region in which more than one object of the plurality of objects are included;
coalescing the more than one object into a new object; and
displaying the new object in the new map.

28. A computer-readable medium tangibly encoding software instructions which are executable to cause one or more data processing apparatus to perform operations comprising:
displaying a plurality of objects in a map of a geographic region displayed in a display device, each of the plurality of objects representing one or more locations of a plurality of locations, wherein each of the plurality of objects are related to one or more digital media items;
receiving an input to change a zoom level of the map, the input causing a new map of a new geographic region to be displayed in place of the map in the display device; and
in response to the receiving, displaying one or more new objects representing corresponding one or more new locations within the new geographic region, wherein a number of the one or more objects is altered from a number of the plurality of objects based on the change to the zoom level of the map.

29. The computer-readable medium of claim 28, wherein the input to change the zoom level is an input to zoom into the map of the geographic region, the operations further comprising:
determining that a new object of the one or more new objects represents more than one location of the plurality of locations;
dividing the new object into additional new objects, each additional new object representing one or more locations of the plurality of locations; and
displaying the additional new objects in the new map.

30. The computer-readable medium of claim 28, wherein the input to change the zoom level is an input to zoom out of the map of the geographic region, the operations further comprising:
determining that a region of the new map includes a region in which more than one object of the plurality of objects are included;
coalescing the more than one object into a new object; and
displaying the new object in the new map.

31. A system comprising:
one or more computers, wherein at least one computer is coupled to a display device; and
a computer-readable medium tangibly encoding software instructions which are executable to cause the one or more computers to perform operations comprising:
displaying a plurality of objects in a map of a geographic region displayed in a display device, each of the plurality of objects representing one or more locations of a plurality of locations, wherein each of the plurality of objects are related to one or more digital media items;
receiving an input to change a zoom level of the map, the input causing a new map of a new geographic region to be displayed in place of the map in the display device; and
in response to the receiving, displaying one or more new objects representing corresponding one or more new locations within the new geographic region, wherein a number of the one or more objects is altered from a number of the plurality of objects based on the change to the zoom level of the map.

32. The system of claim 31, wherein the input to change the zoom level is an input to zoom into the map of the geographic region, the operations further comprising:
determining that a new object of the one or more new objects represents more than one location of the plurality of locations;
dividing the new object into additional new objects, each additional new object representing one or more locations of the plurality of locations; and
displaying the additional new objects in the new map.

33. The system of claim 31, wherein the input to change the zoom level is an input to zoom out of the map of the geographic region, the operations further comprising:
determining that a region of the new map includes a region in which more than one object of the plurality of objects are included;
coalescing the more than one object into a new object; and
displaying the new object in the new map.

34. A system comprising:
one or more computers, wherein at least one computer is coupled to a display device; and
a computer-readable medium tangibly encoding software instructions which are executable to cause the one or more computers to perform operations comprising:
receiving a portion of a location name in a user interface displayed on the display device, wherein the location name is associated with an image;
retrieving a plurality of suggested names, wherein the plurality of suggested names alphabetically match the portion of the location name;
ordering the suggested names based on a relationship between each suggested name and a reference location to generate a selectable list of suggested names; and
displaying the selectable list of suggested names on the display device.

35. The system of claim 34, the operations further comprising receiving an additional portion of the location name and deleting from the selectable list one or more suggested names that do not alphabetically match the additional portion of the location name.

36. The system of claim 34, wherein the relationship between the reference location and each of the suggested names comprises a distance between the reference location and a location associated with each of the suggested names, and wherein the operations further comprise:
determining the distance between the reference location and a location associated with a suggested name;
determining that the determined distance is less than or equal to a threshold distance; and
including the associated suggested name in the selectable list of suggested names.

37. The system of claim 34, wherein the relationship between the reference location and each of the suggested names is based on a number of images taken at a location corresponding to the suggested name, and wherein the operations further comprise:
ordering the selectable list of suggested names based on the number of images taken at each location corresponding to a suggested name.

38. A computer-readable medium tangibly encoding software instructions which are executable to cause one or more data processing apparatus to perform operations comprising:
receiving a portion of a location name in a user interface displayed on the display device, wherein the location name is associated with an image;
retrieving a plurality of suggested names, wherein the plurality of suggested names alphabetically match the portion of the location name;
ordering the suggested names based on a relationship between each suggested name and a reference location to generate a selectable list of suggested names; and
displaying the selectable list of suggested names on the display device.

39. The computer-readable medium of claim 38, the operations further comprising receiving an additional portion of the location name and deleting from the selectable list one or more suggested names that do not alphabetically match the additional portion of the location name.

40. The computer-readable medium of claim 38, wherein the relationship between the reference location and each of the suggested names comprises a distance between the reference location and a location associated with each of the suggested names, and wherein the operations further comprise:
determining the distance between the reference location and a location associated with a suggested name;
determining that the determined distance is less than or equal to a threshold distance; and
including the associated suggested name in the selectable list of suggested names.

41. The computer-readable medium of claim 38, wherein the relationship between the reference location and each of the suggested names is based on a number of images taken at a location corresponding to the suggested name, and wherein the operations further comprise:
ordering the selectable list of suggested names based on the number of images taken at each location corresponding to a suggested name.

42. A computer-implemented method comprising:
receiving a portion of a location name in a user interface displayed on the display device, wherein the location name is associated with an image;
retrieving a plurality of suggested names, wherein the plurality of suggested names alphabetically match the portion of the location name;
ordering the suggested names based on a relationship between each suggested name and a reference location to generate a selectable list of suggested names; and
displaying the selectable list of suggested names on the display device.

43. The method of claim 42, further comprising receiving an additional portion of the location name and deleting from the selectable list one or more suggested names that do not alphabetically match the additional portion of the location name.

44. The method of claim 42, wherein the relationship between the reference location and each of the suggested names comprises a distance between the reference location and a location associated with each of the suggested names, and wherein the operations further comprise:
determining the distance between the reference location and a location associated with a suggested name;
determining that the determined distance is less than or equal to a threshold distance; and
including the associated suggested name in the selectable list of suggested names.

45. The method of claim 42, wherein the relationship between the reference location and each of the suggested names is based on a number of images taken at a location corresponding to the suggested name, and wherein the operations further comprise:
ordering the selectable list of suggested names based on the number of images taken at each location corresponding to a suggested name.
